(19) United States
(12) Patent Application Publication
(10) Pub. No.: US 2004/0228411 A1
(43) Pub. Date: Nov. 18, 2004

(54) Method and system for decoder clock control in presence of jitter

(75) Inventors: Ryuichi Iwamura, San Diego, CA (US); Takaaki Ota, San Diego, CA (US)

Correspondence Address: ROGITZ & ASSOCIATES, Suite 3120, 750 B Street, San Diego, CA, 92101, US

(73) Assignees: SONY CORPORATION, Tokyo (JP); SONY ELECTRONICS INC., Park Ridge, NJ

(21) Appl. No.: 10/663,420

(22) Filed: Sep. 16, 2003

Related U.S. Application Data
(60) Provisional application No. 60/469,771, filed on May 12, 2003.

(51) Int. Cl. H04N 7/12

(52) U.S. Cl. 375/240.25; 375/240.12

(57) ABSTRACT

In a non-isochronous network, jitter in received multimedia streams is accounted for by adjusting the decoder clock according to how full the receive buffer is. When the buffer appears to be filling up, the decoder clock is sped up, and when the buffer is perceived to be emptying, the decoder clock is slowed down, avoiding the respective artifacts of frame dropping and freeze framing.

### RELATED APPLICATIONS

This application claims priority from U.S. provisional patent application Ser. No. 60/469,771, filed May 12, 2003.

### I. FIELD OF THE INVENTION

The present invention relates generally to decoders, and more particularly to MPEG decoders.

### II. BACKGROUND OF THE INVENTION

Digital multimedia streams may be sent to receivers using satellite networks or cable broadcast networks or other networks. The multimedia can be formatted in accordance with Moving Pictures Expert Group (MPEG) standards such as MPEG-1, MPEG-2 (also used for DVD format), MPEG-4 and other block based transform codecs.

In MPEG formatting, the data is encoded using MPEG principles, sent to the receiver, and then decoded at the receiver. Periodically (e.g., every forty milliseconds) a program clock reference (PCR) data block is transmitted within the stream. The PCR block essentially tells the decoder what time the encoder thinks it is, a necessary piece of information to support proper decoding. Using the information in the PCR blocks, the decoder can repeatedly adjust its clock as appropriate to optimize decoding.

This works well in isochronous or constant-delay networks such as the IEEE 1394 network, where each packet of multimedia is timestamped before transmission so that the receiver can inject the packet into its correct place in the stream during decoding. So-called “jitter”, a term referring to unintended and usually undesirable temporal dislocations of data, is strictly regulated and minimized in isochronous networks to the point where periodic PCR packets are all that are required from a time synchronization standpoint to adequately decode a multimedia stream.

On the other hand, the present invention recognizes that non-isochronous or variable delay networks such as, for instance, Ethernet or 802.11 networks, do not guarantee a constant delay for packet delivery, and jitter looms a larger impediment to successful decoding. Conventional PCR based clock recovery mechanisms fail under this circumstance. The decoder thus runs with a clock which is not synchronized with the encoder clock. Consequently, in these networks, small differences between the encoder clock and decoder clock can accumulate over time. When the decoder clock runs too fast, the received data buffer in which the multimedia is temporarily stored prior to decoding eventually can be emptied by the decoder faster than it is replenished by the received encoded stream, in which case the currently employed “solution” is simply to present, as a still picture, the last decoded video frame until the buffer fills up with new data to be decoded. In contrast, when the decoder clock runs too slow, the data buffer fills up faster than the data can be emptied from it and decoded. In this case, the current “solution” is simply to drop frames, causing skips in the display of the multimedia stream. In both cases, the visual and audio artifacts are distracting to the viewer.

### SUMMARY OF THE INVENTION

A system includes a receive data buffer and a decoder assembly receiving data from the buffer for decoding thereof. The decoder assembly includes a clock that has a rate which is established based on how full of data the buffer is.

In a preferred embodiment, a non-isochronous network conveys multimedia data to a receiver that embodies the buffer and decoder assembly. The data may be formatted in MPEG.

As set forth further below, the clock rate may be established by a buffer occupancy level. The preferred buffer occupancy level is a time-averaged buffer occupancy level that may be established based on plural instantaneous buffer occupancy levels sequentially spaced by a temporal distance equal to a sampling interval. Or, the time-averaged buffer occupancy level may be established based on a maximum instantaneous buffer occupancy level and a minimum instantaneous buffer occupancy level.

In any case, the clock rate may be decreased in response to a determination that the buffer occupancy level is relatively low. In contrast, the clock rate may be increased in response to a determination that the buffer occupancy level is relatively high. If desired, the clock rate can be changed depending on the rate of change of the buffer occupancy level.

In another aspect, a multimedia receiver includes a buffer holding data to be decoded and a decoder communicating with the buffer. A clock component sends a clock signal to the decoder. According to present principles, a processor executes logic to establish a clock rate associated with the clock component. The logic includes determining a buffer occupancy level of the buffer, and based on the buffer occupancy level, establishing the clock rate.

In yet another aspect, a computer-implemented method for establishing a decoder clock rate includes receiving, into a buffer, data to be decoded at a sampling interval. The method includes determining how full the buffer is and based thereon determining whether to increase or decrease the sampling interval.

In still another aspect, a system for establishing a decoder clock rate includes buffer means for receiving data to be decoded, and means for determining a buffer occupancy level. Means are provided for establishing a clock rate for decoding data in the buffer based at least in part on the buffer occupancy level.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing the present system;

FIG. 2 is a flow chart showing the general logic of the present invention for establishing the decoder clock rate;

FIG. 3 is a graph of buffer occupancy versus time to illustrate a first method for obtaining a smoothed buffer occupancy level; and

FIG. 4 is a graph of buffer occupancy versus time to illustrate a second method for obtaining a smoothed buffer occupancy level.

### DETAILED DESCRIPTION OF THE PREFERRED EMBODIMENT

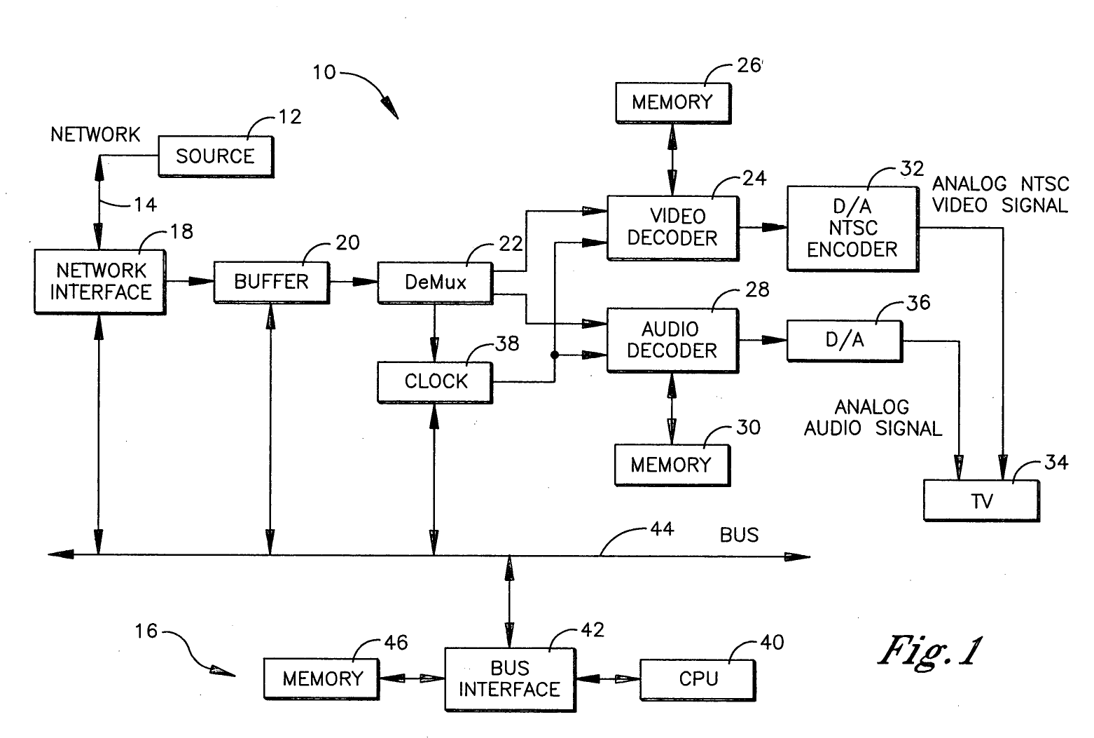

Referring initially to FIG. 1, a system is shown, generally designated 10, in which a source 12, e.g., a satellite, or a cable broadcast source, or a wireless broadcast source, and so on of data, e.g., multimedia data, sends data over a network 14 to one or more receivers 16. The network 14 may be a non-isochronous network such as but not limited to a IEEE 802.11 wireless network or a wired or wireless Ethernet, although the present principles can be applied to other non-isochronous networks as well as to isochronous networks.

In the non-limiting illustrative embodiment of FIG. 1, the receiver 16 includes a network interface component 18 in accordance with principles known in the art that receives multimedia data streams from the network 14 and sends the streams to a data buffer 20. It is the occupancy level of this buffer that is monitored and based on which the decoder clock rate is established, although occupancy levels of other buffers and/or memories shown herein may be used. The network 14 may send streams of more than one program of different time-bases that are multiplexed. Each program consists of its own video and audio data. In this case a buffer after the demultiplexer 22, such as a bitstream buffer of video decoder 24 which resides in the memory 26, may serve better for monitoring purposes.

Data from the buffer 20 is sent to a demultiplexer 22 which separates the audio and video portions of the stream. Video data is sent to a video decoder 24 that may access a video memory 26, while audio data is sent to an audio decoder 28 that may access an audio memory 30. Decoded video information can be sent to a digital to analog NTSC encoder 32 for conversion in accordance with principles known in the art to a format suitable for presentation on a television 34 or other output device. Similarly, decoded digital audio information may be sent to a digital to analog converter 36 for conversion to an analog signal suitable for playing on the TV 34.

As shown in FIG. 1, a clock component 38 sends a clocking signal to the decoders 24, 28. In one non-limiting embodiment the clocking signal may have a frequency of roughly twenty seven million Hertz (27 MHz). It is to be understood that the clock component 38 may include a phase-locked loop in accordance with principles known in the art for establishing the actual clock rate in accordance with logic set forth further below.

A digital processor such as a central processing unit (CPU) 40 may communicate with the components mentioned above through a bus interface component 42 and a main data bus 44. The CPU 40 may also access a memory 46 through the bus interface 42. While FIG. 1 shows that the network interface 18, buffer 20, demultiplexer 22, and clock component 38 are connected to the bus 44, it is to be understood that the decoders 24, 28 as well as other components may also be connected to the bus 44. Except for the inventive logic disclosed below (which may be stored in the memory 46 and executed by the CPU 40) and how it cooperates with the above-described components, it may now be understood that the preferred non-limiting receiver 16 shown in FIG. 1 may be a conventional digital TV receiver.

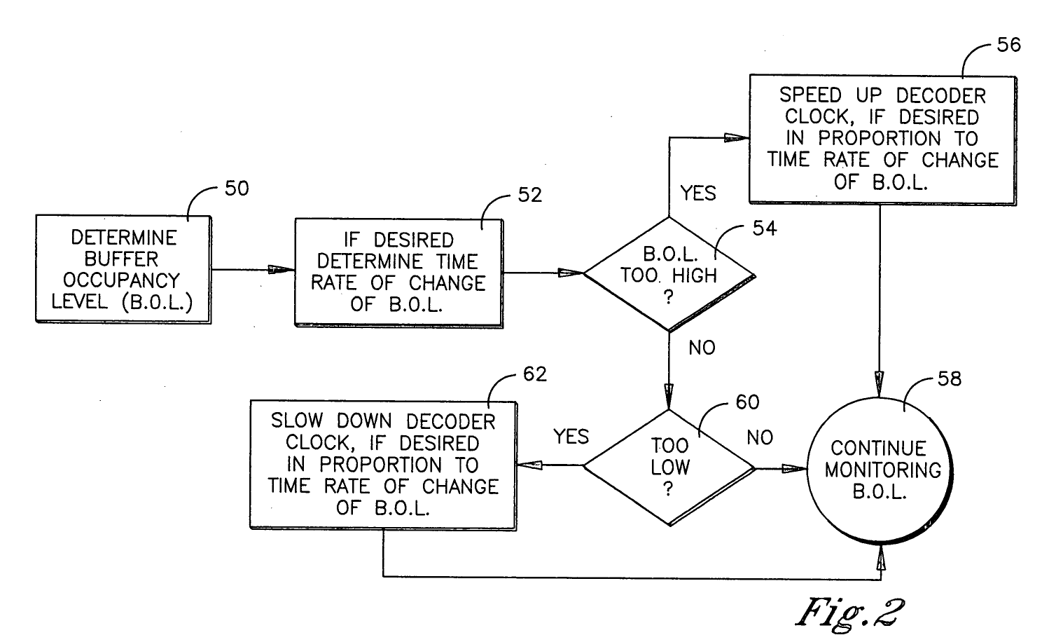

Now referring to block 50 in FIG. 2, a buffer occupancy level of the buffer 20 is determined. The occupancy level may be the instantaneous occupancy level or more preferably as set forth further below a time-averaged occupancy level. By “occupancy level” is meant how full the buffer 20 is of data from the network 14.

The logic may if desired next move to block 52 to determine how fast the occupancy level of the buffer 20 is changing. Then, at decision diamond 54 it is determined whether the occupancy level is too high, i.e., it is determined whether the buffer 20 is too full, meaning an overflow condition has or is about to occur, as might be indicated by, e.g., the buffer 20 holding an amount of data in excess of a threshold amount. If so, the logic moves to block 56 to cause the phase-locked loop of the clock component 38 to increase the clock rate and, hence, the sampling frequency of the decoders 24, 28 in FIG. 1. If desired, the amount by which the rate is increased may be proportional to the time rate of change (in this case, time rate of increase) of buffer 20 occupancy level. The logic then continues to monitor the buffer occupancy level in accordance with the logic above at state 58.

When it is determined at decision diamond 54 that the occupancy level of the buffer 20 is not too high, the preferred logic can flow to decision diamond 60 to determine whether it is too low. If not, the logic monitors the buffer occupancy level in accordance with the logic above at state 58. On the other hand, if it is determined at decision diamond 60 that the occupancy level is too low, meaning an underflow condition has or is about to occur, the logic moves to block 62 to cause the phase-locked loop of the clock component 38 to decrease the clock rate and, hence, the sampling frequency of the decoders 24, 28 in FIG. 1. If desired, the amount by which the rate is decreased may be proportional to the time rate of change (in this case, time rate of decrease) of buffer 20 occupancy level. The logic then continues to monitor the buffer occupancy level in accordance with the logic above at state 58.

While the logic above is depicted in flow chart format for ease of disclosure, it is to be understood that the logic may be depicted or implemented in state machine structure or other suitable program code structure

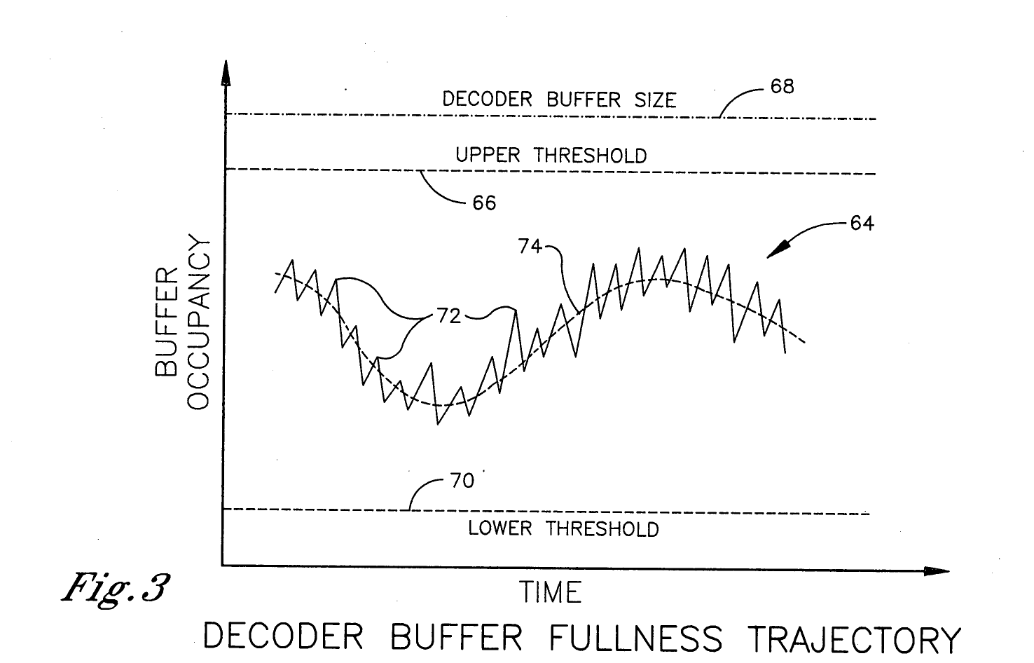

As mentioned above, to prevent excessively frequent and potentially destabilizing clock rate adjustments, a time-averaged buffer occupancy level may be used in the tests at decision diamonds 54 and 60. FIG. 3 shows a graph of buffer occupancy level versus time, wherein the buffer occupancy is maintained between an upper threshold 66 (which is set somewhat below the total buffer capacity 68) and a lower threshold 70. Points 72 of the jagged line in FIG. 3 represent instantaneous buffer 20 occupancy levels, with each point 72 corresponding to the occupancy level at a respective sampling interval. The smooth line 74 represents the time-averaged occupancy level.

To obtain a time-averaged occupancy level, “N” successive instantaneous occupancy levels may be averaged together. For instance, the instantaneous occupancy levels of the buffer 20 over five successive sampling intervals may be averaged, with the average value used at decision diamonds 54 and 60 in FIG. 2.

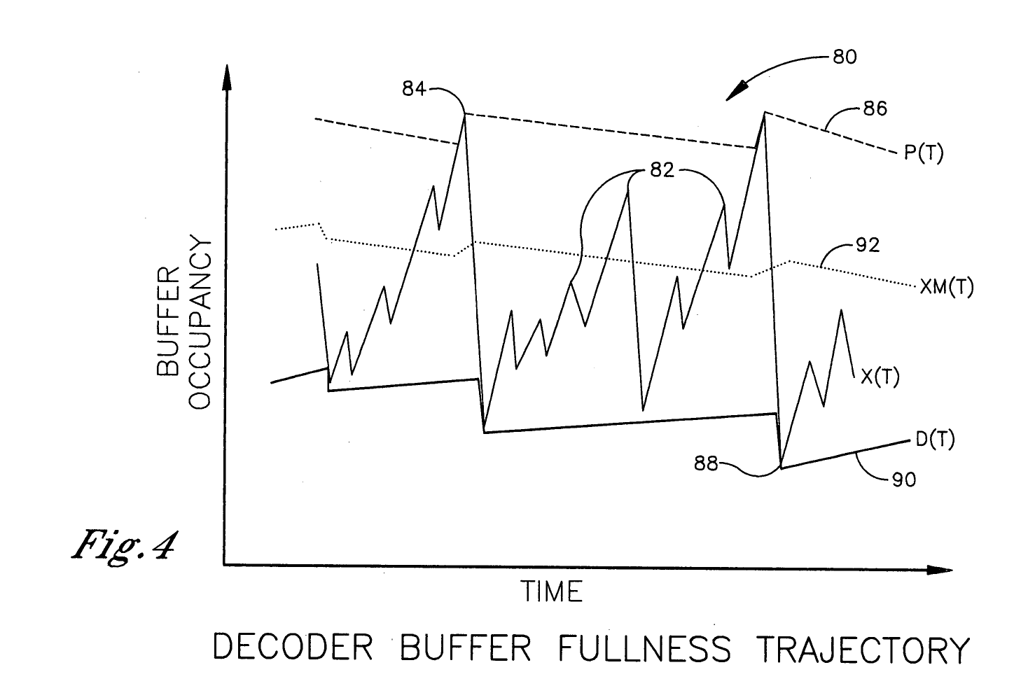

Or, as illustrated in FIG. 4, the time-averaged buffer occupancy level may be based on maximum and minimum instantaneous buffer occupancy levels. More particularly, FIG. 4 shows a graph of buffer occupancy level versus time, wherein points 82 of the jagged line in FIG. 4 represent instantaneous buffer 20 occupancy levels and wherein points 84 are maximum level peaks (which abstractly can be connected by the dotted line 86 labelled p(t)) and further wherein peaks 88 are minimum level peaks (which abstractly can be connected by the bolded line 90 labelled d(t)). The line 92, labelled xm(t), represents a time-averaged occupancy level that can be used in decision diamonds 54 and 60 of FIG. 2 and determined as follows.

xm(t)={p(t)+d(t)}/2, wherein

p(t)=max {x(t), p(t−Δt)−α};

d(t)=min {x(t), d(t−Δt)+α};

wherein t=sampling time, Δt=sampling interval, x(t)=instantaneous buffer occupancy level at time t, p(t)=peak value at time t, d(t)=minimum (dip) value at time t, the function max (x,y)=x for x>y, otherwise=y, the function min (x,y)=x for x≦y, otherwise=y, and α=empirically determined decay coefficient to avoid peak value p(t) increasing monotonously and dip value d(t) decreasing monotonously.

While the particular METHOD AND SYSTEM FOR DECODER CLOCK CONTROL IN PRESENCE OF JITTER as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

WE CLAIM:

What is claimed is:

1. A system, comprising:
a receive data buffer; and
a decoder assembly receiving data from the buffer for decoding thereof, the decoder assembly including a clock, a rate of the clock being established at least in part based on how full of data the buffer is.

2. The system of claim 1, comprising a non-isochronous network conveying multimedia data to a receiver embodying the buffer and decoder assembly.

3. The system of claim 2, wherein the data is formatted in MPEG.

4. The system of claim 1, wherein the rate is established at least in part by a buffer occupancy level.

5. The system of claim 4, wherein the buffer occupancy level is a time-averaged buffer occupancy level.

6. The system of claim 5, wherein the time-averaged buffer occupancy level is established at least in part based on plural instantaneous buffer occupancy levels.

7. The system of claim 4, wherein the rate is decreased in response to a determination that the buffer occupancy level is relatively low and wherein the rate is increased in response to a determination that the buffer occupancy level is relatively high.

8. The system of claim 4, wherein the rate is changed depending at least in part on a rate of change of the buffer occupancy level.

9. The system of claim 5, wherein the time-averaged buffer occupancy level is based at least in part on a maximum instantaneous buffer occupancy level and a minimum instantaneous buffer occupancy level.

10. A multimedia receiver, comprising:
at least one buffer holding data to be decoded;
at least one decoder communicating with the buffer;
at least one clock component sending a clock signal to the decoder; and
at least one processor executing logic to establish a clock rate associated with the clock component, the logic including:
determining a buffer occupancy level of the buffer; and
at least in part based on the buffer occupancy level, establishing the clock rate.

11. The receiver of claim 10, wherein the logic comprises determining a time-averaged buffer occupancy level for use in the establishing step.

12. The receiver of claim 11, wherein the time-averaged buffer occupancy level is established at least in part based on plural instantaneous buffer occupancy levels.

13. The receiver of claim 11, wherein the logic comprises decreasing the clock rate in response to a determination that the buffer occupancy level is relatively low and increasing the clock rate in response to a determination that the buffer occupancy level is relatively high.

14. The receiver of claim 11, wherein the logic includes:
determining a rate of change of the buffer occupancy level; and
changing the clock rate at least in part based on the rate of change of the buffer occupancy level.

15. The receiver of claim 11, wherein the time-averaged buffer occupancy level is based at least in part on a maximum instantaneous buffer occupancy level and a minimum instantaneous buffer occupancy level.

16. A computer-implemented method for establishing a decoder clock rate, comprising the acts of:
receiving into a buffer data to be decoded at a sampling interval;
determining how full the buffer is; and
based on the determining act, determining whether to increase or decrease the sampling interval.

17. The method of claim 16, comprising determining how full the buffer is using a time-averaged buffer occupancy level.

18. The method of claim 17, wherein the time-averaged buffer occupancy level is based at least in part on a maximum instantaneous buffer occupancy level and a minimum instantaneous buffer occupancy level.

19. The method of claim 16, comprising increasing or decreasing the sample interval based at least in part on a time rate of change of a buffer occupancy level.

20. A system for establishing a decoder clock rate, comprising:
buffer means for receiving data to be decoded;
means for determining a buffer occupancy level; and
means for establishing a clock rate for decoding data in the buffer means based at least in part on the buffer occupancy level.

21. The system of claim 20, comprising means for determining a time-averaged buffer occupancy level.

22. The system of claim 21, wherein the time-averaged buffer occupancy level is based at least in part on a maximum instantaneous buffer occupancy level and a minimum instantaneous buffer occupancy level.

23. The system of claim 20, comprising means for altering the clock rate based at least in part on a time rate of change of a buffer occupancy level.
